(19) United States
(12) Patent Application Publication
(10) Pub. No.: US 2011/0022793 A1
(43) Pub. Date: Jan. 27, 2011

(54) Systems And Methods For Accessing Hard Disk Drives

(76) Inventor: Walter A. Gaspard, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/935,284

(22) PCT Filed: Mar. 31, 2008
(86) PCT No.: PCT/US08/58834

§ 371 Date: Sep. 28, 2010

(51) Int. Cl. G06F 12/00

(52) U.S. Cl. 711/112; 711/E12.001

(57) ABSTRACT

The present disclosure generally pertains to systems and methods for accessing hard disk drives. In one exemplary embodiment, a computer system comprises a hard disk drive (HDD), an operating system, and a translation element. The operating system is configured to transmit an HDD access command, which has a sector count indicating a first number of hard drive sectors to be accessed in response to the HDD access command. The translation element is configured to receive the HDD access command and to translate the HDD access command into a translated access command having a new sector count indicating a second number of hard drive sectors to be accessed in response to the translated access command. The second number is different than the first number, and the translation element is configured to transmit the translated access command to the hard disk drive.

### RELATED ART

A computer system often employs a hard disk drive (HDD), sometimes referred to as a “hard drive,” to store various data. Access to the hard drive is usually controlled by an operating system (OS). In this regard, the operating system issues HDD access commands for writing to or reading from the hard drive. Such access commands are received by the hard drive, which accesses (e.g.: reads or writes) data on the hard drive in response to such commands.

A hard disk is logically divided into multiple sectors, which are separately addressable by the HDD access commands. However, for various reasons, it may be desirable to change the sector size of the hard drive. For example, it may be desirable to append additional error correction coding (ECC) bytes to the data written to or read from the hard disk. To help mitigate the effect of these additional ECC bytes to the performance of the computer, the size of each HDD sector may be increased. For example, some conventional hard drives have a sector size of 512 bytes such that up to 512 bytes of data can be stored to each sector of the hard drive. However, recently, many computer manufacturers are migrating to a sector size of 4096, sometimes referred to as “4k,” such that up to 4096 bytes of data can be stored to each sector of the hard drive.

Unfortunately, the operating system is typically formatted for a hard drive of a specific sector size. Thus, a computer manufacturer or designer may be precluded from transitioning to a desired sector size until an operating system compatible with the desired sector size becomes available.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a conventional computer system.

FIG. 2 is a block diagram illustrating a conventional hard disk drive (HDD).

FIG. 3 is a block diagram illustrating an exemplary embodiment of a computer system.

FIG. 4 is a block diagram illustrating an exemplary hard disk drive (HDD), such as is depicted in FIG. 3.

FIG. 5 is a block diagram illustrating an exemplary translation element, such as is depicted in FIG. 3.

FIG. 6 is a flow chart illustrating an exemplary method for performing a read operation in response to an HDD read command.

FIG. 7 is a flow chart illustrating an exemplary method for performing a write operation in response to an HDD write command.

### DETAILED DESCRIPTION

The present disclosure generally pertains to systems and methods for accessing hard disk drives. In one exemplary embodiment, a computer system has a hard disk drive, an operating system, and a translation element. The operating system transmits an access command, such as a read command or a write command, for accessing the hard drive. The operating system formats the access command for a hard disk drive of a specific size. The translation element receives the access command and translates the access command into a format for a hard disk drive of a different size. The translation element transmits the translated access command to the hard disk drive of the computer system, and the hard disk drive accesses a disk in response to the translated access command. Since the translation element appropriately translates access commands into a form that is compatible with the hard disk drive, it is unnecessary for the operating system to be configured to format access commands in accordance with the sector size of the hard disk drive.

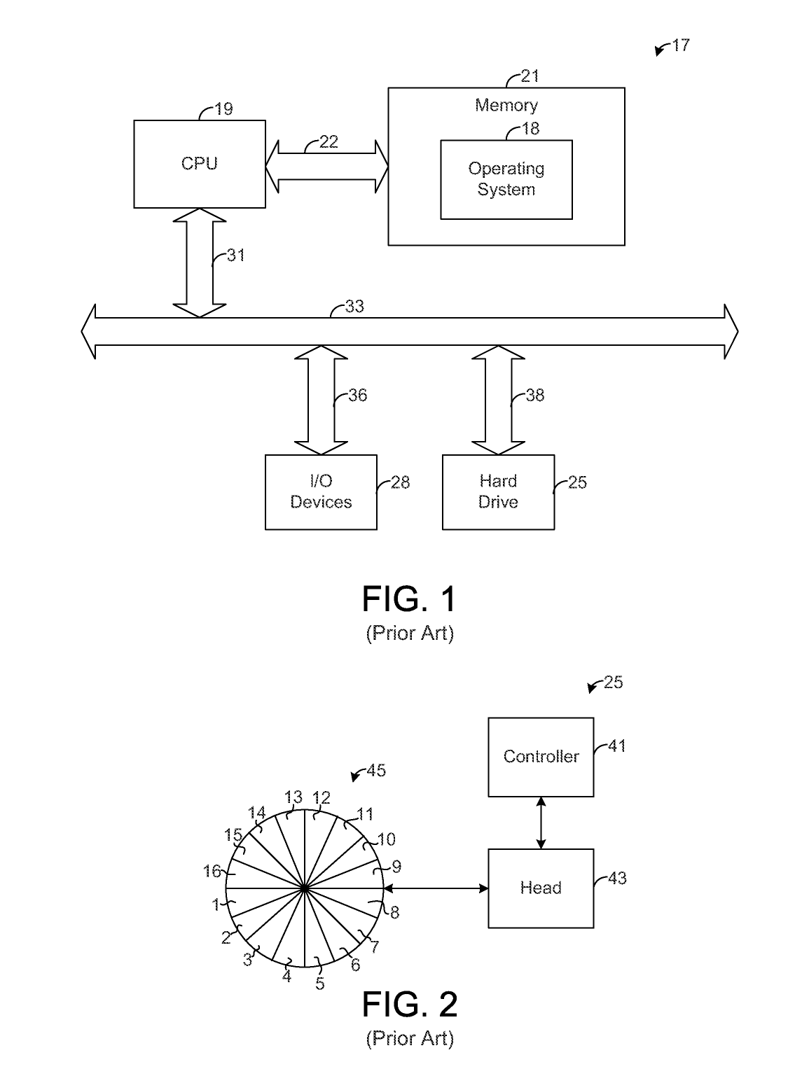

FIG. 1 depicts a conventional computer system 17. The computer system 17 has a central processing unit (CPU) 19 that executes instructions of various software and/or firmware stored in the system 17. For example, an operating system (OS) 18 is stored in memory 21, which can be accessed by the CPU 19 via a memory bus 22. The operating system 18 controls the allocation and usage of various resources in the system 17, such as a hard disk drive (HDD) 25, which will be described in more detail hereafter.

The CPU 19 is interfaced with various system components, such as input/output (I/O) devices 28 and the hard disk drive 25 via at least one bus. For example, in FIG. 1, a CPU bus 31 couples the CPU 19 to a system bus 33, sometimes referred to as a “southbridge bus.” I/O devices 28 are coupled to the system bus 33 via an I/O bus 36, and the hard drive 25 is coupled to the system bus 33 via an HDD bus 38. The HDD bus 38 is often a serial advanced technology attachment (ATA) bus.

As shown by FIG. 2, the hard drive 25 comprises a controller 41, a head 43, and at least one memory disk 45. The controller 41 can be implemented in hardware, software, firmware, or any combination thereof, and the controller 41 generally controls the operation of the drive 25. The head 43 is a hardware device, which is actuated by the controller 41 in order to read from or write to the disk 45. The controller 41 logically segments the disk 45, for reading and writing operations, into separately addressable sectors. A “sector” generally refers to the smallest physical storage unit on the disk 45. Thus, when accessing a sector, the head 43 either reads from or writes to the entire sector.

In the example shown by FIG. 2, the controller 41 logically divides the disk 45 into sixteen sectors (i.e., sectors 1-16) for illustrative purposes. However, the disk 45 may have any number of sectors depending on the overall size of the disk 45 and the desired sector size of the disk 45. In this regard, for a given disk size, increasing the size of each sector generally reduces the number of sectors on the disk 45, and decreasing the size of each sector generally increases the number of sectors on the disk 45. The sector size is typically selected based on various design considerations and is often based on various system-specific parameters, such as the bus sizes of the computer system 17 in which the drive 25 is expected to be used. Moreover, the design considerations can change for different computer systems, and it, therefore, may be desirable to use disks having different sector sizes for different computer systems.

During operation, the operating system 18 transmits, to the hard drive 25, HDD access commands, such as HDD read commands or HDD write commands. Generally, an HDD access command typically includes a command identifier, a sector count, and a logical address, although it is possible for HDD access commands to include other types of information. The command identifier indicates whether the command is for reading from or writing to the hard drive 25. The logical address identifies a logical memory location and, in particular, a disk sector at which a reading or writing operation is to start. Further, the sector count is a value indicating the number of disk sectors that are to be accessed in response to the command. Note that the sector count is based on the length of data that is being written or read, as well as the sector size of the hard drive 25.

For example, assume that the sector size for the hard drive 25 is 512 bytes such that each sector 1-16 of the hard drive 25 is capable of storing up to 512 bytes of data. Further assume that an HDD access command for reading the hard drive 25, also referred to as a “read command,” instructs the hard drive 25 to read 4096 bytes of data starting with sector 3. In this example, the operating system 18 inserts, into the command, a command identifier that identifies the command as being a read command. The operating system 18 also inserts a logical address that identifies sector 3. Since 4096 bytes span across eight disk sectors, the operating system 18 inserts a count value of eight into the command indicating that the hard drive 25 is to read eight sectors in response to the access command.

The access command is transmitted from the CPU 19 to the hard drive 25.

The controller 41 receives the access command and maps the logical address within such command to a physical address on the disk 45 to which the head 43 is to be moved before commencing the read operation (e.g., the start of sector 3). The controller 41 then instructs the head 43 to move to this physical address. Based on the sector count, the controller 41 appropriately controls the head 43 such that the head 43 consecutively reads sectors 3-11, staring with the identified sector (i.e., sector 3 in this example). Thus, controller 41 returns 4096 bytes of data to the CPU 19 in response to the access command.

An HDD access command for writing to the hard drive 25, also referred to as a “write command,” is similar to a read command, except that the write command includes the data to be written to the hard drive 25. Upon receiving the write command, the controller 41 maps the logical address in the command to a physical location on the disk 45, as described above for the read command. The controller 41 also controls the head 43 such that the data included in the write command is written to the disk 45 beginning at the physical location mapped to the logical address and continuing sector-by-sector until the sector count has been reached. For example, if a write command identifies sector 3, has 4096 bytes of data, and has a sector count of 8, then the controller 41 controls the head 43 such that the 4096 bytes are written to the disk 45 starting at sector 3 and continuing until sector 11.

Typically, if a computer manufacturer or designer desires to select a sector size different than the one used by the operating system 18, then the operating system 18 is updated to change how it formats the access commands so that the logical addresses and sector counts used by the operating system 18 are consistent with the hard drive 25 that is to be used.

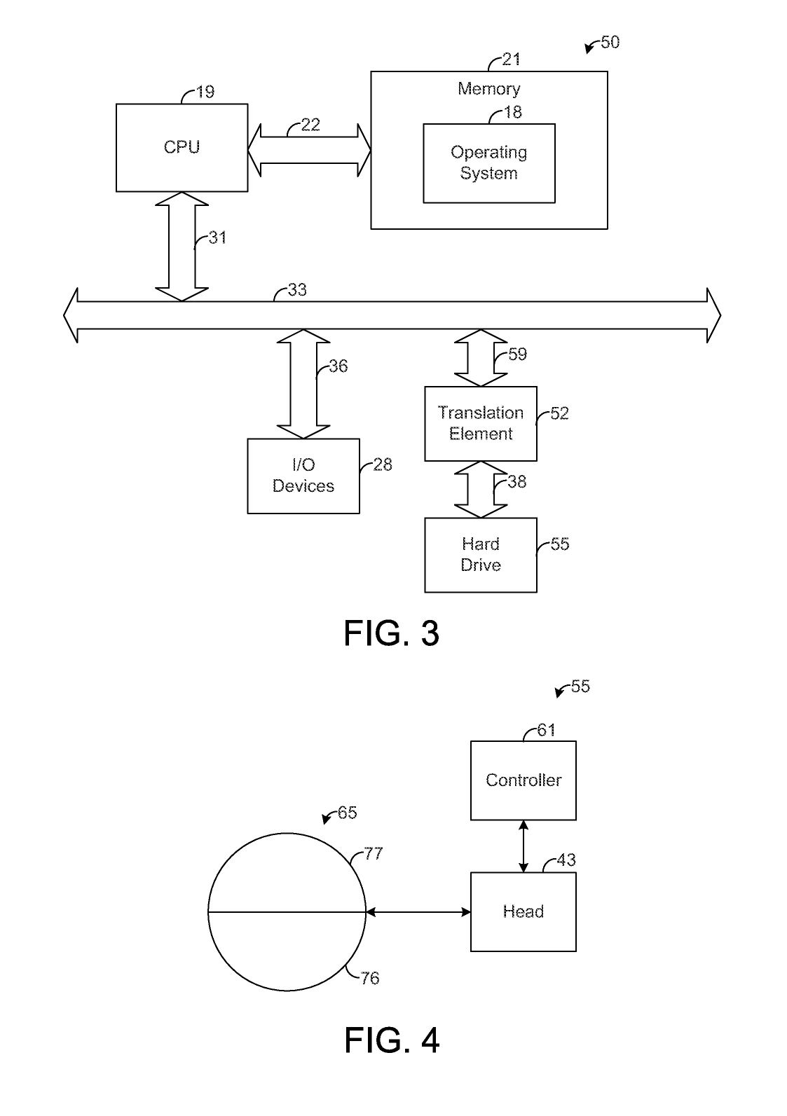

FIG. 3 depicts an exemplary embodiment of a computer system 50 in accordance with the present disclosure. The exemplary computer system 50 of FIG. 3 is essentially identical to the conventional computer system 17 shown by FIG. 1 except that the system 50 has a translation element 52, as well as a hard disk drive 55 with a different sector size relative to the hard disk drive 25 of FIG. 1. In this regard, for illustrative purposes, assume that the hard drive 55 has a sector size of 4096 or “4k.” However, in other embodiments, the hard drive 55 may have other sector sizes. As can be seen by comparing FIGS. 2 and 4, the configuration of the hard drive 55 is similar to that of the conventional hard drive 25 except that a controller 61 maps logical addresses in accordance with a sector size that is different than the sector size of hard drive 25. In the instant embodiment, the controller 61 maps logical addresses for a disk 65 based on a 4k sector size. Thus, if the overall sizes of the disk 45 (FIG. 2) and disk 65 (FIG. 4) are equal, then the disk 65 would have two sectors, assuming that disk 45 has sixteen sectors. For simplicity of illustration, it will be assumed hereafter that the disk 65 has two sectors 76, 77, but other numbers of sectors are possible in other embodiments.

In the exemplary embodiment depicted by FIG. 3, the translation element 52 is coupled to the system bus 33 via a bus 59, which is a serial ATA bus, like the HDD bus 38, although other types of buses may be used in other embodiments. The translation element 52 is configured to receive access commands transmitted from the CPU 19 and to translate the access commands into forms compatible with the hard drive 52. In this regard, as described above, the operating system 18 forms the access commands in accordance with a sector size that is inconsistent with that of the hard drive 55. Thus, except for the translation performed by the element 52, the access commands would be incompatible with the hard drive 55. However, the translation element 52 translates a received access command into a suitable command for the hard drive 55. Therefore, in the instant embodiment, the operating system 18 operates as if the hard drive 55 has a sector size of 512 bytes, and the translation element 52 updates the access commands transmitted from the operating system 18 such that the translated commands are appropriately processed by the hard drive 55 even though the hard drive 55 has a sector size of 4k bytes rather than 512 bytes.

Note that in translating a received access command, the translation element 52 preferably translates the command's sector count into a new sector count suitable for the hard drive 55. In this regard, if “x” represents the HDD sector size on which the operating system 18 is based and if “y” represents the actual sector size of the hard drive 55, then the value of the sector count assigned to the translated command is equal to S (x/y), where “S” represents the original sector count of the command being translated. For example, in the instant embodiment for which the operating system 18 is based on a sector size of 512 and for which the actual sector size of the hard drive 55 is 4k or, in other words, 4096, the new sector count for the translated command can be determined by multiplying the sector count in the original command by ⅛ (i.e., 512/4096). If the calculation results in a fraction, then the new sector count is preferably rounded up to next highest whole number. For example, if the original sector count is 9 such that the new sector count is calculated to be 1.125, then the new sector count is rounded to a value of 2.

Thus, in the example described above for which the operating system 18 transmits a command for reading 4096 bytes of data and inserts a sector count of 8 into the command, the translation element 52 translates the sector count of such command into a value of 1. Therefore, the translated command transmitted to the hard drive 55 has a sector count of 1.

In addition to translating the sector count, the translation element 52 may also translate the logical address of a received access command. In this regard, in one exemplary embodiment, the translation element 52 maps logical addresses from the operating system 18 to logical addresses of the hard drive 55. Further, it is possible for logical addresses for multiple sectors (in accordance with the sector size used by the operating system 18) to be mapped to a logical address for the same sector for the hard drive 55 and vice versa. For example, assume that the operating system 18 is configured to access a disk of a hard drive having sixteen sectors with a sector size of 512 bytes, and assume that the disk 65 of the hard drive 55 has two sectors 76, 77 with a sector size of 4096. In such an example, all of the logical addresses from the operating system 18 are mapped to the two sectors of the hard drive 55. For example, the addresses that would have been mapped to the first eight sectors of a hard drive with a 512 byte sector size are mapped to one sector of the hard drive 55, and the addresses that would have been mapped to the last eight sectors of a hard drive with a 512 byte sector size are mapped to the other sector of the hard drive 55.

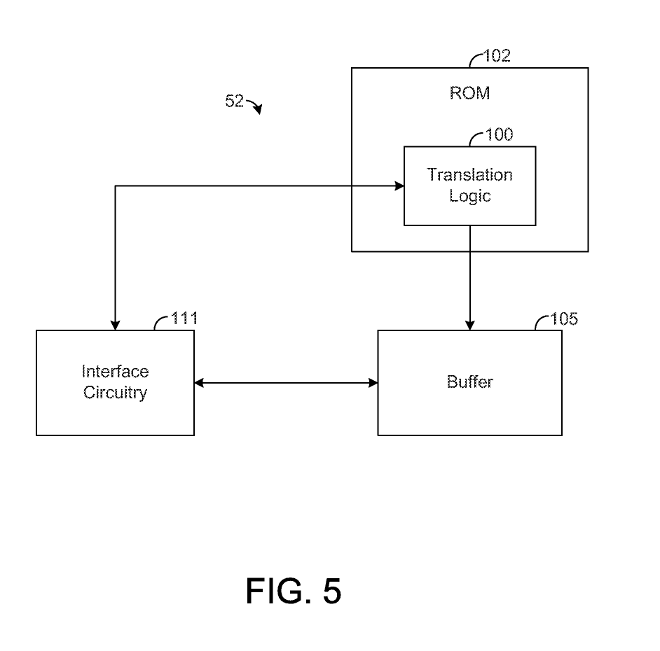

FIG. 5 depicts an exemplary configuration of the translation element 52. In the exemplary embodiment depicted by FIG. 5, the element 52 comprises translation logic 100 that is implemented in firmware and stored in read only memory (ROM) 102. In other embodiments, the translation logic 100 can be implemented in software, firmware, hardware, or any combination thereof.

As shown by FIG. 5, the translation element 52 also comprises a buffer 105 where data (e.g., data from HDD access commands) can be temporarily stored. Interface circuitry 111 is configured to interface the buffer 105 with buses 38, 59 (FIG. 3). During operation, the interface circuitry 111 also retrieves instructions from the translation logic 100 and transmits such instructions to CPU 19 for execution to enable the logic 100 to run on CPU 19.

In one exemplary embodiment, all of the components of the translation element 52 shown by FIG. 5 are packaged within a single integrated circuit (IC) chip (not specifically shown). In such an embodiment, the interface circuitry 111 comprises IC pins (not specifically shown) that are electrically coupled to the buses 38, 59. However, in other embodiments, other configurations of the translation element 52 are possible, and it is unnecessary for the translation element 52 to be implemented on a single IC.

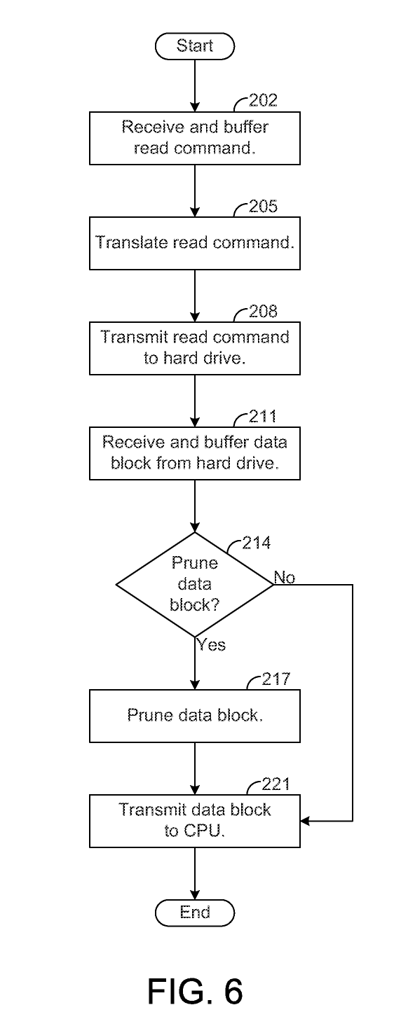

When an HDD read command is transmitted by the operating system 18, the read command is received via the interface circuitry 111, which stores the read command to buffer 105, as shown by block 202 of FIG. 6. The translation logic 100 translates the read command into a form suitable for the hard drive 55, as shown by block 205 of FIG. 5. Such translation may include modification of the sector count and the logical address. The translated command is then transmitted to the hard drive 55 via the interface circuitry 111, as shown by block 208 of FIG. 6.

The hard drive 55 performs a read operation in response to the translated command and transmits data from the read operation, referred to hereafter as a “data block,” across bus 38. Such data is received by the interface circuitry 111, which stores the data in buffer 105, as shown by block 211 of FIG. 6. Before sending the data to the CPU 19, the translation element 100 determines whether to prune the data block in order to remove any unwanted data from the data block, as shown by block 214 of FIG. 6. In this regard, it is possible for the data block to include more data than was actually requested by the operating system 18. In such case, the translation element 100 prunes the data block or, in other blocks, removes some of the data of the data block, as shown by block 217 of FIG. 6, such that only the requested portion of the data block is returned to the CPU 19 in block 221.

For example, assume that the operating system 18 desires to retrieve data from two sectors (in accordance with the sector size used by the operating system 18) such that the read command requests 1024 bytes of data. In this regard, assume that the operating system 18 is requesting data that would have been stored in sectors 3 and 4 of the disk 45 shown by FIG. 2 if a hard drive having a sector size of 512 bytes was used. However, in the instant embodiment, the hard drive 55 has a sector size of 4096 bytes, and all of the requested data is stored in a single sector 76. Nevertheless, since the operating system 18 is operating in accordance with a sector size of 512 bytes, the operating system 18 inserts, into the read command, a sector count of 2 and a logical address that would have identified sector 3 of the disk 45 of FIG. 2.

When the read command is received by the translation element 52, the translation logic 100 translates the sector count to 1 since the requested data is located within a single sector of the disk 65, and the translation logic 100 translates the logical address to one that identifies the sector 76 that is storing the requested data.

Therefore, in response to the translated read command, the hard drive 55 reads sector 76 and returns, to the translation element 52, a data block that includes the 4096 bytes stored in sector 76. However, as noted above, the operating system 18 originally requested 1024 bytes of the 4096 bytes received by the translation element 52. Thus, the translation logic 100 removes, from the received data block, 3072 bytes of unwanted information such that the block includes the 1024 bytes requested from the hard drive 55. The translation logic 100 then transmits the modified data block to the CPU 19 via the interface circuitry 111. Accordingly, the CPU 19 receives the 1024 bytes originally requested by the operating system 18. The CPU 19 may then use such bytes in any desired manner. For example, the CPU 19 may display an output based on the received data via the I/O devices 28.

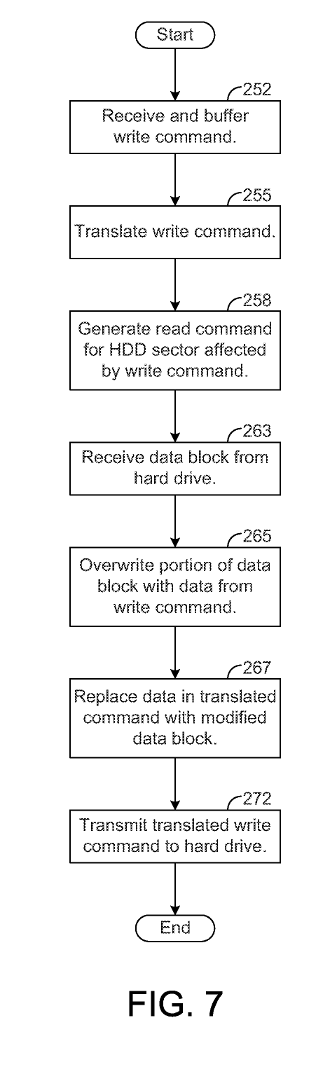

When an HDD write command is transmitted by the operating system 18, the write command is received via the interface circuitry 111, which stores the write command to buffer 105, as shown by block 252 of FIG. 7. The translation logic 100 translates the write command into a form suitable for the hard drive 55, as shown by block 255 of FIG. 7. Such translation may include modification of the sector count and the logical address. The translation may also include a modification of the data in the write command. In this regard, the write command may include less than a full sector of data. In such case, the translation logic 100 is configured to retrieve, from the hard disk 55, a data block for a full sector and to overwrite a portion of this data block with the data in the original write command. The modified data block is then inserted into the translated write command.

To better illustrate the foregoing, assume that the operating system 18 desires to write data to two sectors (in accordance with the sector size used by the operating system 18) such that the write command is for writing 1024 bytes of data. In this regard, assume that the operating system 18 is requesting a write operation that would have written data to sectors 3 and 4 of the disk 45 shown by FIG. 2 if a hard drive having a sector size of 512 bytes was used. However, in the instant embodiment, the hard drive 55 has a sector size of 4096 bytes, and the write operation is for writing to only a portion of the sector 76. Nevertheless, since the operating system 18 is operating in accordance with a sector size of 512 bytes, the operating system 18 inserts, into the read command, a sector count of 2 and a logical address that would have identified sector 3 of the disk 45 of FIG. 2.

When the write command is received by the translation element 52, the translation logic 100 translates the sector count to 1 since the data is to be written to a single sector of the disk 65, and the translation logic 100 translates the logical address to one that identifies the sector 76 to be accessed.

In addition, before transmitting the translated write command, the translation logic 100 generates a read command for reading the sector 76 that is identified by the translated write command, as shown by block 258 of FIG. 7. In response to this read command, the hard drive 55 reads sector 76 and returns, to the translation element 52, a data block that includes the 4096 bytes stored in sector 76, as shown by block 263 of FIG. 7. Of this 4096 bytes, 1024 bytes are to be overwritten by the 1024 bytes included in the original write command transmitted by the operating system 18. The translation logic 100 overwrites such 1024 bytes in the data block with the data from the write command and inserts the entire data block, as modified by the translation logic 100, into the translated write command, as shown by blocks 265, 266 of FIG. 7. The translation logic 100 then transmits the translated write command to the hard drive 55, as shown by block 272 of FIG. 7.

In response to the translated write command, the hard drive writes the 4096 byte block included in such command to the sector 76. Thus, the 1024 bytes in the original write command transmitted by the operating system 18 is written to the sector 76 without changing the remaining 3072 bytes stored in the sector 76.

Moreover, the translation element 52 can be used to enable a computer manufacturer or designer to migrate to a hard drive of different sizes without redesigning the operating system 18 or waiting for an updated version of the operating system 18. In this regard, assume that a manufacturer of the conventional computer system 17, which employs a hard drive 25 having sector sizes of 512 bytes, desires to begin manufacturing computer systems employing hard drives having sector sizes of 4096 bytes. One option is to change the configuration of the operating system 18 to be compatible with hard drives having sector sizes of 4096. However, an alternative approach is to continue using the same version of the operating system 18 for new computer systems but include a translation element 52 for converting access commands into a format compatible with hard drives having sector sizes of 4096. Moreover, rather than changing the configuration of the operating system 18, the manufacturer may begin manufacturing computer systems in accordance with the configuration shown by FIG. 3.

During operation of such a computer system 50, the translation element 52 appropriately translates access requests from a format compatible with hard drives having sector sizes of 512 bytes to a format compatible with hard drives having sector sizes of 4096 bytes.

It should noted that various modifications to the exemplary embodiments described above would be apparent to one of ordinary skill in the art upon reading this disclosure. For example, the translation element 52 is described above as residing between the hard drive 55 and a southbridge bus 33 of a computer system 50. However, other locations of the translation element 52 are possible in other embodiments. In addition, buses of types other than those specifically described herein are possible.

Furthermore, it should be emphasized that the exemplary sector sizes described above are presented for illustrative purposes. Other sector sizes are possible in other embodiments. In this regard, it is possible for the operating system 18 to format access requests that are compatible with hard drives having any sector size other than 512 bytes. In addition, it is also possible for the hard drive 55 to have any sector size other than 4096 bytes and for the translation element 52 to translate access commands into formats compatible with such other sector sizes. Furthermore, it is unnecessary for the actual sector size of the hard drive 55 to be larger than the one on which the operating system 18 is based. For example, it is possible for the operating system 18 to format access command in accordance with a sector size of 4096 bytes, and it is possible for the sector size of the hard drive 55 to be 512 bytes or any other size. Regardless of the sector sizes used by the operating system 18 and the hard drive 55, the translation element 52 is configured to translate HDD access commands from a format incompatible with the hard drive 55 to a format compatible with the hard drive 55.

Now, therefore, the following is claimed:

1. A computer system, comprising:
a hard disk drive (HDD);
an operating system configured to transmit an HDD access command, the HDD access command having a sector count indicating a first number of hard drive sectors to be accessed in response to the HDD access command; and
a translation element configured to receive the HDD access command and to translate the HDD access command into a translated access command having a new sector count indicating a second number of hard drive sectors to be accessed in response to the translated access command, the second number different than the first number, the translation element configured to transmit the translated access command to the hard disk drive.

2. The computer system of claim 1, wherein the hard disk drive is configured to access data stored on a hard disk in response to the translated access command, and wherein the computer system is configured to display an output based on the accessed data.

3. The computer system of claim 1, wherein the HDD access command has a logical HDD address, wherein the translation element is configured to translate the logical HDD address into a new logical HDD address for the translated access command.

4. The computer system of claim 1, wherein the hard disk drive is configured to read a data block from a hard disk and to transmit the data block to the translation element in response to the translated access command.

5. The computer system of claim 4, wherein the translation element is configured to prune the data block and to transmit the pruned data block to a central processing unit (CPU).

6. The computer system of claim 1, wherein the hard disk drive is configured to write a first data block to a hard disk of the hard disk drive in response to the translated access command.

7. The computer system of claim 6, wherein the translation element is configured to transmit, in response to the HDD access command, a read command to the hard disk drive.

8. The computer system of claim 7, wherein the hard disk drive is configured to read a second data block from the hard disk and transmit the second data block to the translation element in response to the read command, and wherein the translation element is configured to insert data from the second data block into the translated access command.

9. A computer system, comprising:
a hard disk drive (HDD) having a hard disk, a controller, and a head, the controller configured to control the head in accordance with a first sector size for the hard disk;
an operating system configured to define an HDD access command in accordance with a second sector size that is different than the first sector size, the operating system configured to transmit the HDD access command; and
a translation element configured to receive the HDD access command and to translate the HDD access command into a translated access command in accordance with the first sector size, the translation element further configured to transmit the translated access command to the hard disk drive.

10. The computer system of claim 9, wherein the HDD access command indicates that a first number of HDD sectors are to be accessed in response to the HDD access command, wherein the translated access command indicates that a second number of HDD sectors are to be accessed in response to the translated access command, and wherein the first number is different than the second number.

11. The computer system of claim 9, wherein the HDD access command has a first sector count, wherein the translated access command has a second sector count, and wherein the first sector count is different than the second sector count.

12. The computer system of claim 9, wherein the controller is configured to access data stored on the hard disk in response to the translated access command, and wherein the computer system is configured to display an output based on the accessed data.

13. The computer system of claim 9, wherein the controller is configured to read, via the head, a data block from the hard disk and to transmit the data block to the translation element in response to the translated access command, and wherein the translation element is configured to prune the data block and to transmit the pruned data block to a central processing unit (CPU).

14. The computer system of claim 9, wherein the controller is configured to write, via the head, a data block to the hard disk in response to the translated access command, and wherein the translation element is configured to transmit a read command to the hard disk drive in response to the HDD access command.

15. A method for use in a computer system, comprising:
transmitting a hard disk drive (HDD) access command from a central processing unit, the HDD access command indicating that a first number of HDD sectors are to be accessed in response to the HDD access command;
translating the HDD access command into a translated access command, the translated access command indicating that a second number of HDD sectors are to be accessed in response to the translated access command, the second number different than the first number;
transmitting the translated access command to a hard disk drive; and
accessing a hard disk of the hard disk drive in response to the access command.

16. The method of claim 15, wherein the HDD access command has a first sector count, and wherein the translated access command has a second sector count that is different than the first sector count.

17. The method of claim 15, further comprising displaying an output based on the accessing.

18. The method of claim 15, wherein the accessing comprises reading a data block from the hard disk, and wherein the method further comprises:
pruning the data block; and
transmitting the pruned data block to a central processing unit of the computer system.

19. The method of claim 15, wherein the accessing comprises writing a data block to the hard disk, and wherein the method further comprises transmitting a read command to the hard disk drive in response to the HDD access command.
